(19) United States
(12) Patent Application Publication
(10) Pub. No.: US 2007/0280581 A1
(43) Pub. Date: Dec. 6, 2007

(54) Optical pressure measuring apparatus

(75) Inventor: Torsten Wipiejewski, Pak Shek Kok (CN)

Correspondence Address: BUCHANAN, INGERSOLL & ROONEY PC, POST OFFICE BOX 1404, ALEXANDRIA, VA, 22313-1404, US

(73) Assignee: HONG KONG APPLIED SCIENCE AND TECHNOLOGY RESEARCH INSTITUTE CO. LTD., Pak Shek Kok (CN)

(21) Appl. No.: 11/447,070

(22) Filed: Jun. 6, 2006

(51) Int. Cl. G02B 6/26; G01N 21/55

(52) U.S. Cl. 385/12; 385/13; 356/445

(57) ABSTRACT

An apparatus comprising an optical cavity for measuring an applied force or pressure, wherein an applied force or pressure is measured or monitored by measuring deformation of said optical cavity when subject to said applied force or pressure.

### FIELD OF THE INVENTION

This invention relates to force or pressure measuring apparatus and, more particularly, to optical-based force or pressure measuring apparatus.

### BACKGROUND OF THE INVENTION

Pressure measurements are important for many applications. For example, pressure measurements are essential for determining the stress conditions, the stress distribution, or load conditions of an object or a structure. In general, pressure measurements are made by pressure sensors which are placed in contact with a load or a pressure source. The physical properties of a typical pressure sensor are a function of the pressure applied onto the pressure sensor. The pressure sensitive physical properties of a pressure sensor are usually transmitted to signal processing circuitry by wire connection. By processing changes in the physical properties of the pressure sensor, pressure parameters can be obtained.

Piezoelectric pressure sensors are probably a better-known type of conventional pressure sensors. Pressure parameters are typically measured by a piezoelectric sensor through monitoring the variation of electrical characteristics due to variation of pressure. Disadvantages of piezoelectric pressure sensors include the need of wiring, electrical insulation, the need of electrical power supply and a low deployment density.

Optical pressure sensors are known. Optical pressure sensors are known to mitigate disadvantages of conventional electrical-type pressure sensors. For example, optical pressure sensors are known to obviate the need of electrical wiring and insulation, as well as mitigating problems due to electromagnetic interference. For example, exemplary optical pressure sensors have been described in U.S. Pat. Nos. 4,932,262 and 4,875,368. However, known optical pressure sensors are relatively bulky, complicated and require high precision processing for pressure measurements. Therefore, it is desirable if an improved optical pressure sensor can be provided.

### SUMMARY OF THE INVENTION

Accordingly, this invention has described an apparatus for measuring or monitoring an applied force or pressure in which a force and/or pressure is measured by monitoring the deformation of an optical cavity of a pressure sensing block when the pressure sensing block is subject to the applied force or pressure. Since there is a specific relationship between the optical length of an optical block and the instantaneous pressure or force to which an optical block is subject, parameters on deformation of the optical cavity will provide useful information on the applied force or pressure.

An advantage of using optically measurements to ascertain the deformation of a pressure sensor so as to evaluate an applied force or pressure is the possibility of remote sensing which significantly enhances deployment flexibility.

Because the optical length of an optical cavity of an optical block can be measured at a very high accuracy by tracking the optical reflectivity of the optical cavity, an aspect of this invention is the tracking of deformation of an optical pressure sensor block by measuring the optical reflectivity of the optical cavity. In a preferred embodiment, optical reflectivity of an optical cavity is measured by using a coherent light source, and more particularly, a laser source.

In a preferred embodiment, the apparatus comprises a pressure sensing block having a pressure sensing surface and an optical cavity, the optical cavity of said pressure sensing block being deformable by application of force on said pressure sensing surface; an optical arrangement comprising an optical source and an optical receiver, said optical source and said optical receiver being arranged for measuring deformation of said optical cavity of said pressure sensing block; and a processor for correlating the extent of deformation of the optical cavity to the pressure or force applied on the pressure sensing surface.

In an exemplary arrangement of the apparatus, said optical source is arranged for emitting an optical signal to a reflection surface of said optical cavity; and said optical receiver comprises an optical detector for receiving optical signal reflected from the optical cavity.

In another preferred embodiment, the apparatus comprises an optical guide, the optical guide is disposed intermediate said pressure sensing block and said optical arrangement and is arranged for transmitting and received optical signals to and from said reflection surface of said optical cavity.

In an exemplary arrangement, the optical cavity has a reflection surface and deformation of said optical cavity due to application of force on said pressure sensing surface causes displacement of said reflection surface, wherein said optical arrangement being for measuring optical reflectivity of said optical cavity with reference to optical reflection from said reflection surface, the optical reflectivity of said optical cavity being variable and dependent on the extent of displacement of the optical reflection surface, said optical receiver further comprising processing means for measuring the optical reflectivity of the pressure sensing block for determining the applied force or pressure.

In another preferred embodiment, the pressure sensing surface and the reflection surface of said pressure sensing block are non-parallel, the application of force along a first direction on the pressure sensing surface results in displacement of the optical reflection surface along a second and different direction, the optical source being arranged for transmitting light along said second direction. More particularly, said optical cavity having a characteristic optical cavity length, said characteristic optical cavity length being parallel to said second direction.

Preferably, said optical reflection surface defining a characteristic optical cavity length of said optical cavity, said optical source being arranged for transmitting light towards said reflection surface parallel to said optical cavity length, said optical receiver further comprising means for measuring the instantaneous optical cavity length of said optical cavity by measuring optical reflection from said optical reflection surface.

In yet another preferred embodiment, the pressure sensing surface and the reflection surface are non-parallel. More particularly, the pressure sensing surface and the reflection surface are at an angle. Yet more particularly, the pressure sensing surface and the reflection surface are orthogonal to each other. More specifically, the measuring apparatus of that yet another preferred embodiment comprises a prismatic block wherein application of force on said pressure sensing surface results in displacement of said pressure sensing surface, displacement of said pressure sensing surface in turn causes displacement of said reflection surface, characterized in that the ratio of relative displacements between said reflection surface to said pressure sensing surface being between 0.2 to 0.4. Preferably, the pressure sensing block comprises a transparent block of PMMA.

As a convenient example, the optical source comprises a VCSEL laser source. Typically, the pressure sensing block is adapted for measuring a maximum force or pressure corresponding to a displacement of the reflection surface of below 500 nm. In practice, the length of said optical cavity being in the mm range.

According to another aspect of this invention, there is provided a method of measuring an applied force or pressure, the method comprising the following steps:
disposing a pressure sensing block to subject to an applied force, wherein said pressure sensing block comprises an optical cavity of an optical length said optical length being characteristic of a first light wavelength,
measuring and obtaining deformation characteristics of said optical cavity when subject to an applied force or pressure, and
evaluating the applied force or pressure from the deformation characteristics of said optical cavity.
   Preferably, the method further comprises the steps of:—
operating an optical source to transmit light of a first wavelength through said pressure sensing block and along said optical length and,
operating an optical receiver to receive light along said optical length; and
operating a processor to determine the force or pressure applied on the pressure sensing block by referencing to optical reflectivity of said pressure sensing block along said optical length.
   Preferably, the method further comprises the steps of:—
determining an optical length of the optical cavity of said pressure sensing block from measured optical reflectivity of said pressure sensing block along said optical length, and
correlating variations of said optical length with the force or pressure applied to the pressure sensing block.
   Preferably, the method further comprises the steps of:—
Calibrating the optical length of the pressure sensing block with reference to a plurality of values of known applied force or pressure.

The measurement of force or pressure by tracking on the deformation of an optical cavity of a pressure sensor block facilitates simple, efficient and flexible pressure measurement. For example, an optical arrangement can be used to monitor a plurality of pressure sensors.

### BRIEF DESCRIPTION OF THE DRAWINGS

Preferred embodiments of the present invention will be explained in further detail below by way of examples and with reference to the accompanying drawings, in which:—

FIG. 1 is an arrangement showing a first preferred embodiment of this invention and an application thereof,

FIG. 2 illustrates the relationship between an applied force and deformation of an optical cavity of a pressure sensing block of the arrangement of FIG. 1,

FIG. 3 is a chart illustrating the relationship between optical reflectivity verses the change in optical cavity length of an optical cavity of a pressure sensing block of the arrangement of FIG. 1,

FIG. 4 is a chart showing the weight (force) and area relationship of a pressure sensing block of the arrangement of FIG. 1, and

FIG. 5 is an arrangement showing a second preferred embodiment of this invention.

### DETAILED DESCRIPTION OF THE PREFERRED EMBODIMENTS

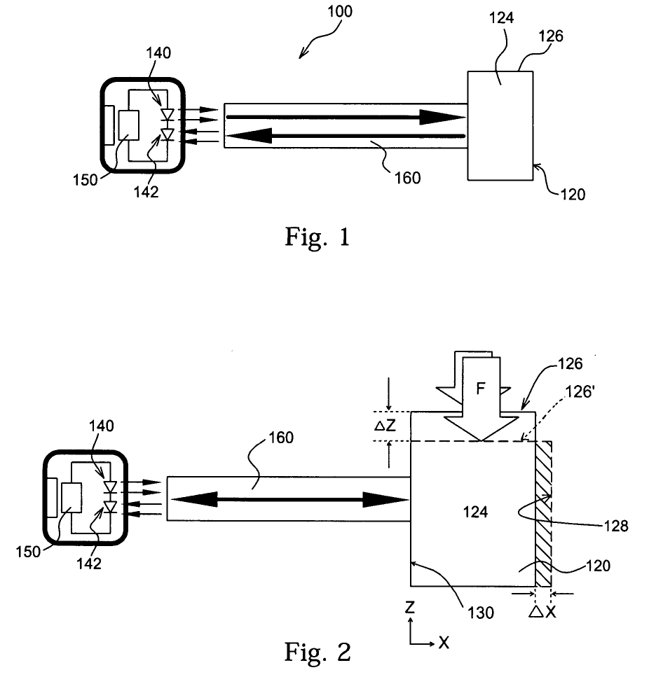

Referring firstly to FIGS. 1 to 4, there is shown a first preferred embodiment of a pressure measuring apparatus.

The measuring apparatus 100 comprises a pressure sensing block 120, an optical arrangement comprising an optical source 140 and an optical receiver 142, and a controller 150 with a processor. The pressure sensing block 120 has a pressure sensing surface 122 and an optical cavity 124. The pressure sensing block is rigid and the optical cavity is deformable by application of force on the pressure sensing surface. An exemplary pressure sensing block which is suitable for this application is a transparent prismatic block made of PMMA.

The optical arrangement comprises an optical source and an optical receiver. The optical source and the optical receiver are arranged for measuring deformation of the optical cavity of the pressure sensing block through optical means.

The processor is for correlating the extent of deformation of the optical cavity to the pressure or force applied on the pressure sensing surface.

In the arrangement of FIG. 1, the optical arrangement and the processor are housed within a single enclosure. The controller controls the operation of the optical source and the optical receiver. The optical source is a laser transmitter with a VCSEL (Vertical-Cavity Surface-Emitter Laser) laser source for emitting a coherent light. An optical fibre waveguide 150 is disposed intermediate the pressure sensing block and the optical arrangement so that an optical signal emitted by the laser source can be transmitted by the optical fibre to the pressure sensor block and light reflected by the pressure sensor block can be returned through the optical fibre waveguide towards the optical detector. An optical fibre will confine the emitted and reflected light within the same optical fibre to mitigate external interference or optical contamination. Although a single optical fibre is illustrated in FIG. 1, it will be understood that separate optical fibre guides can be used respectively for coupling with the optical source and the optical detector. The controller comprises control circuitry for controlling the operation conditions of the optical source so that the intensity of light being transmitted towards the pressure sensor block can be adjusted. To further mitigate adverse interface, the laser source may be modulated. The processor further comprises a measurement circuitry to evaluate the level of light impinging on the photo-detector and compare with the light transmitted by the optical source so as to evaluate the reflectivity by comparing the amount of reflected optical with the amount of optical signal transmitted by the optical source.

Referring to FIG. 2, when a force is applied on a pressure sensing surface 126 of the pressure sensor block, the applied force will cause deformation of the pressure sensing block as shown by the dotted lines. Specifically, an applied force along the two directions will cause the pressure sensing block to shrink by an amount Δz along the z direction and an expansion of the pressure sensing block by Δx along the x direction. The deformation relationship, that is, Δx/Δz, is a material dependent constant given by the Poisson ratio γ. The value of γ is typically in the region of 0.2 to 0.4.

The pressure sensing block has an optical cavity 124 with a reflection surface 128 and a characteristic optical cavity length as illustrated in FIG. 4. Referring to FIG. 4, the optical reflectivity of the optical sensing block as a function of the variation in optical cavity length for an optical beam incident on the pressure sensing block along a direction (x) which is orthogonal to the reflection surface is shown in FIG. 4. For the example of FIG. 4, the pressure sensing block has an initial optical cavity length of 1 mm. The initial optical cavity length corresponds to a condition of nil applied pressure so that there is nil deformation on the optical cavity length. The pressure sensing block is a rigid transparent block made of PMMA (Polymethyl Methacrylate), although other transparent prismatic materials can also be used. The maximum reflectivity of each of the reflecting surfaces 128, 130 of the sensor block vis-à-vis an incident beam towards the reflection surfaces is about 30% each. Reflectivity minima occur at a variation of optical cavity length of about 20 nm and 310 nm due to destructive interference of an incident beam as reflected by the first 128 and the second 130 reflective surfaces. On the other hand, the reflective maxima with a reflectivity of near 0.7 occurs at around 180 nm of Δx deformation. A complete cycle of cavity length variation between two reflectivity minima is about 280 nm. By calibrating the reflectivity with known applied pressures and obtaining a chart of FIG. 4, the deformation of the optical length due to an applied pressure as exemplified by the variation of the optical length can be evaluated. As the applied force or pressure is dependent on the deformation of the optical cavity, the applied force or pressure can be obtained by standard physics equations.

Turning next to an application of the pressure measuring apparatus of FIGS. 1 and 2 comprising the pressure sensing block, an optical arrangement comprising an optical source and an optical receiver, and a processor. Firstly, the optical arrangement and the pressure sensing block are arranged so that an optical beam emitted by the optical source is transmitted orthogonally towards the first 128 and the second 130 reflection surfaces of the pressure sensor block. The optical detector is arranged so that light reflected by the first and the second reflection surfaces will be collected by the photo-detector. An optical fibre waveguide is disposed intermediate the pressure sensing block and the optical arrangement so that the emitted and reflected light will be confined within an optical waveguide to mitigate interference or contamination by external light sources. This optical fibre waveguide is optional and can be replaced by two separate optical fibre waveguides respectively for the optical source and the optical detector. The optical source in this example is a coherent light source such as a laser source, for example, a VCSEL (Vertical-Cavity Surface-Emitter Laser) laser source.

The controller of the arrangement comprises information relating to the reflectivity characteristics of the optical cavity length of the pressure sensing block. By measuring the reflectivity of the pressure sensing block, the variation in cavity length can be derived from the pre-stored characteristics and the applied force or pressure can be obtained without undue difficulty.

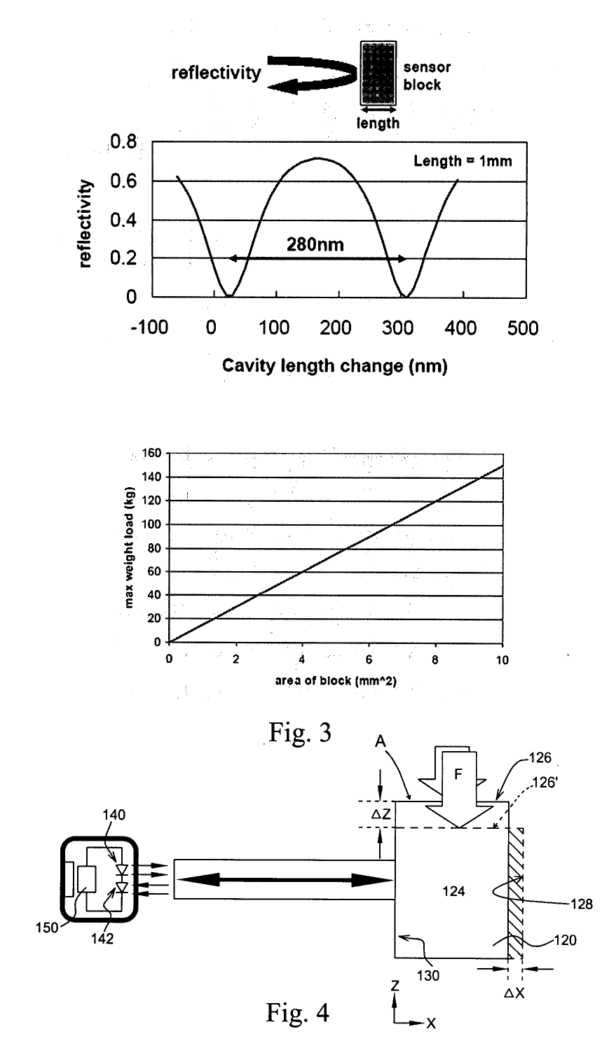

Turning next to the operation of the arrangement of FIG. 2, when a force is applied on a pressure sensing surface of the pressure sensing block, the pressure sensing block will be deformed and so will be the optical cavity. As a more specific example, when an applied force causes a shrinkage of Δz along the z direction (the direction of application of force), the pressure sensing block will expand along the orthogonal axis x for an amount Δx. The relationship between Δz and the applied pressure is a known material parameter which can be pre-stored in the controller or the associated processor or through on-site calibration. Furthermore, as the variation Δx along the x axis will be reflected by the change in reflectivity due to the change in the optical cavity length as shown in FIGS. 3, the variation of Δx can be obtained. Since the relationship between Δx and Δz is a material dependent on the Poisson ratio, the deformation along the z axis, which is parallel to the direction of the applied force, can be evaluated and the applied pressure can then be evaluated. After the pressure has been evaluated, the applied force can be obtained by multiplying the pressure with the surface area of the pressure sensing surface according to the chart of FIG. 4. Hence, the pressure measuring apparatus of this invention is highly scalable by varying the size of the pressure sensing surface of the pressure sensing block. In this preferred embodiment, the optical beam that is being used to measure optical reflectivity is orthogonal to the direction of the applied force. This orthogonal arrangement provides enhanced flexibility since it is not usually possible to measure deformation of the pressure sensing block along the direction of the applied force, namely, the z axis. To further enhance deployment flexibility, a plurality of pressure sensing blocks can be distributed under a load or a plurality of loads so that the load or pressure variation among the various locations can be monitored by one or a plurality of the optical arrangements.

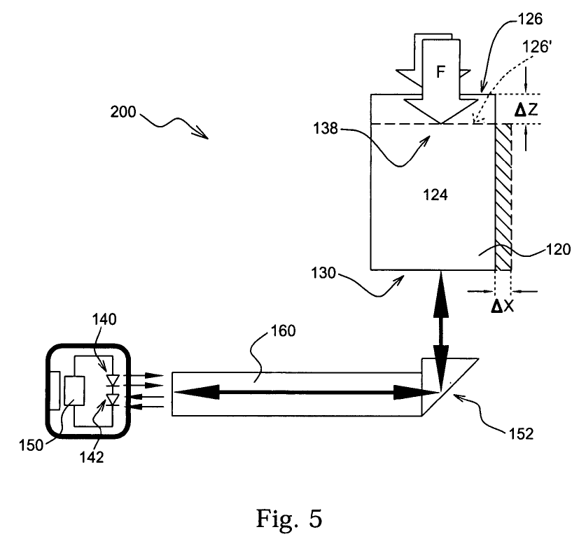

Referring to FIG. 5, there is shown a second preferred embodiment 200 of the invention. In this preferred embodiment, the deformation of the pressure sensing block along the direction of the applied force (z) is measured to directly ascertain the applied force or pressure. The arrangement is substantially identical to the arrangement of FIGS. 1 and 2 except that the optical fibre waveguide is arranged so that the light emitted by the optical source will impinge on first 138 and second 130 reflective surfaces of the pressure sensing block wherein the reflective surfaces 138, 130 are orthogonal to the direction of the applied force. As shown in FIG. 5, an optical beam emitted by the optical source is deflected for 90° by a prism 152 through total internal reflection so that the emerging light will be incident on the reflective surfaces of the pressure sensing block and the two reflective surfaces are orthogonal to that used in FIGS. 1 and 2. This arrangement provides enhanced flexibility when it is desirable or preferable that light should be incident direct on reflective surfaces which are parallel to the pressure sensing surface. In this case, the pressure sensing surface is the same as the second reflective surface of the pressure sensing block.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to a sensor block of PMMA, it should be appreciated that the invention can apply, whether with or without modification, to pressure sensors of other materials without loss of generality.

1. An apparatus comprising a pressure sensing block having a pressure sensing surface and an optical cavity for measuring an applied force or pressure, wherein said apparatus is arranged such that an applied force or pressure acting on said pressure sensing surface of said pressure sensing block is measured or monitored by measuring a change in optical length of said optical cavity when subject to said applied force or pressure.

2. An apparatus according to claim 1, wherein said change in optical length of said optical cavity is measured by measuring optical reflectivity or a variation in optical reflectivity of said optical cavity.

3. An apparatus according to claim 1, wherein said apparatus comprises:
optical arrangement comprising an optical source and an optical receiver, said optical source and said optical receiver being arranged for measuring optical reflectivity or a variation in optical reflectivity of said optical cavity due to deformation of said optical cavity of said pressure sensing block along its optical length; and
a processor for correlating the extent of said deformation in optical length of the optical cavity to the pressure or force applied on the pressure sensing surface.

4. An apparatus according to claim 3, wherein
said optical source is arranged for emitting an optical signal to a reflection surface of said optical cavity; and
said optical receiver comprises an optical detector for receiving optical signal reflected from the optical cavity.

5. An apparatus according to claim 4, further comprising an optical guide, wherein said optical guide is disposed intermediate said pressure sensing block and said optical arrangement, and said optical guide is further arranged for transmitting optical signal towards said optical cavity and for receiving optical signals reflected from said reflection surface of said optical cavity.

6. An apparatus according to claim 3, wherein said optical cavity has a distal reflection surface and deformation of said optical cavity due to application of force on said pressure sensing surface causes a lengthwise displacement of said distal reflection surface along said optical length, wherein said optical arrangement being for measuring optical reflectivity of said optical cavity with reference to optical reflection from said distal reflection surface, the optical reflectivity of said optical cavity being variable and dependent on the extent of said lengthwise displacement of the optical reflection surface, and wherein said optical receiver further comprises processing means for measuring the optical reflectivity of the pressure sensing block for determining the applied force or pressure.

7. An apparatus according to claim 6, wherein the pressure sensing surface and the distal reflection surface of said pressure sensing block are non-parallel, and the application of force along a first direction on the pressure sensing surface results in displacement of the optical reflection surface along a second and different direction, and wherein the optical source is arranged for transmitting light along said second direction.

8. An apparatus according to claim 7, wherein said optical cavity has a characteristic optical cavity length defined by a proximal reflection surface and a distal reflection surface, said characteristic optical cavity length being parallel to said second direction.

9. An apparatus according to claim 6, wherein said optical reflection surface defines a characteristic optical cavity length of said optical cavity, and said optical source is arranged for transmitting light towards said distal reflection surface in a direction parallel to said optical cavity length, said optical receiver further comprising means for measuring the instantaneous optical cavity length of said optical cavity by measuring optical reflection from said distal reflection surface.

10. An apparatus according to claim 6, wherein the pressure sensing surface and the distal reflection surface are non-parallel.

11. An apparatus according to claim 10, wherein the pressure sensing surface and the distal reflection surface are at an angle.

12. An apparatus according to claim 11, wherein the pressure sensing surface and the distal reflection surface are orthogonal to each other.

13. An apparatus according to claim 6, wherein said pressure sensing block comprises a prismatic block and wherein application of force on said pressure sensing surface resulting in displacement of said pressure sensing surface which in turn causing displacement of said reflection surface, characterized in that the ratio of relative displacements between said reflection surface to said pressure sensing surface is between 0.2 to 0.4.

14. An apparatus according to claim 13, wherein the pressure sensing block comprises a transparent block of PMMA.

15. An apparatus according to claim 14, wherein the optical source comprises a VCSEL laser source.

16. An apparatus according to claim 13, wherein the pressure sensing block is adapted for measuring a maximum force or pressure corresponding to a displacement of the reflection surface of below 500 nm.

17. An apparatus according to claim 16, wherein the length of said optical cavity being in the mm range.

18. A method of measuring an applied force or pressure, the method comprising the following steps:
subjecting a pressure sensing block to an applied force, wherein said pressure sensing block comprises an optical cavity having a predetermined optical length said optical length being characteristic of a first light wavelength,
measuring and obtaining information on a change in said optical length of said optical cavity when said pressure sensing block is subject to an applied force or pressure, and
evaluating the applied force or pressure from the change in optical length of said optical cavity through measuring the optical reflectivity of said optical cavity.

19. A method of claim 18, further comprising the steps of:—
operating an optical source to transmit light of a first wavelength through said pressure sensing block and along said optical length and,
operating an optical receiver to receive light along said optical length; and
operating a processor to determine the force or pressure applied on the pressure sensing block by referencing to optical reflectivity of said pressure sensing block along said optical length.

20. A method of claim 19, further comprising the steps of:—
determining an optical length of the optical cavity of said pressure sensing block from measured optical reflectivity of said pressure sensing block along said optical length, and
correlating variations of said optical length with the force or pressure applied to the pressure sensing block.

21. A method of claim 19, further comprising the steps of:—
Calibrating the optical length of the pressure sensing block with reference to a plurality of values of known applied force or pressure.

22. An apparatus for measuring force or pressure, said apparatus comprising a pressure sensing block and an optical arrangement, wherein:
said pressure sensing block comprises a pressure sensing surface and an optical cavity having a predetermined and characteristic optical length, the optical length of said optical cavity being variable in response to force or pressure applied on said pressure sensing surface, and
said optical arrangement is arranged to measure a change in optical length of said optical cavity by evaluating variation in optical reflectivity of said optical cavity; and
said apparatus is arranged to correlate the variation in optical reflectivity of said optical cavity to the force or pressure acting on said pressure sensing surface.
